(19) United States
(12) Patent Application Publication
(10) Pub. No.: US 2023/0092223 A1
(43) Pub. Date: Mar. 23, 2023

(54) Chain Stay Protection Element and Chain Stay System

(71) Applicant: Canyon Bicycles GmbH, Koblenz (DE)

(72) Inventors: Peter Alraun, Koblenz (DE); Stephan Vogt, Koblenz (DE)

(21) Appl. No.: 17/949,547

(22) Filed: Sep. 21, 2022

(30) Foreign Application Priority Data
Sep. 22, 2021 (DE) 20 2021 105 108.6

(51) Int. Cl. B62K 19/44

(52) U.S. Cl. CPC B62K 19/44

(57) ABSTRACT

A chain stay protection element is for the arrangement of a chain stay of a bicycle frame. The chain stay protection element includes a cover element arranged on an outer side of the chain stay in the area of the chainring in the mounted state. For fastening the cover element, the latter is connected to a fastening element.

### CROSS-REFERENCE TO RELATED APPLICATION

This application claims priority to German Patent Application No. 20 2021 105 108.6 filed Sep. 22, 2021, the disclosure of which is hereby incorporated by reference in its entirety.

### BACKGROUND OF THE DISCLOSURE

### Field of the Disclosure

The disclosure relates to a chain stay protection element and a chain stay system having such a chain stay protection element.

### Description of Related Art

In bicycles having a derailleur, the chain is tensioned by a spring mechanism on the rear derailleur. However, during cycling, vibrations occur which move the chain and, in particular, cause it to oscillate. In doing so, the chain may strike the chain stay or other parts of the bicycle frame, resulting in damage to the bicycle chain and/or the bicycle frame. Such movements of the chain may also be caused by irregular transmission of forces. This is particularly the case with mountain bikes and the like due to the vibrations that occur. Similar movements of the chain may also occur on bicycles having a suspended rear frame. During compression, the distance between the bottom bracket and the rear axle changes for many types of bicycles. This causes, depending on the direction of movement of the rear frame, a stretching or relaxing of the chain. Such sudden movements of the chain, in particular a relaxation or a tensioning of the chain, often leads to the chain striking the bicycle frame, particularly the chain stay. Such uncontrolled movements of the chain can also cause the chain to be thrown off the chainring and possibly jam between the chainring and chain stay. This can not only lead to damages to the chain and the bicycle frame but also to the fall of the cyclist.

In order to protect the chain stay, it is known to place a cover element on the upper side of the chain stay. The cover element also serves as a sound absorber. Such cover elements are particularly required for chain stays made of carbon. The cover elements are often designed as plastic parts with possibly damping properties and/or made of rubber-like material. Furthermore, it is known, in particular for carbon frames, to provide a protection element, also made of sheet metal, in the area between the chainring and the chain stay in order to prevent damage to the frame when the chain jams in this area.

### SUMMARY OF THE DISCLOSURE

An object of the disclosure is to provide an improved chain stay protection element.

According to the disclosure, the object is achieved by the features as described herein, with respect to a chain stay protection element, and by the features as described herein, with respect to a chain stay system.

The chain stay protection element according to the disclosure is for arrangement on a chain stay of a bicycle. The chain stay protection element has a cover element which, in the mounted state, is disposed on an outer side of the chain stay. In particular, the cover element is disposed in the area of the chainring on the outer side of the chain stay. Furthermore, the chain stay protection element has a fastening element for fastening the chain stay protection element to the chain stay. The fastening element is connected to the cover element or integrated into the cover element. The fastening can also be achieved by bonding so that the fastening element is formed by the bonding. Fastening can also be achieved by fastening in a clamping manner, for example by partially encompassing a frame element, such as a chain stay, as well as by screwing or the like, wherein different fastening elements can also be combined with one another.

By arranging a cover element on the outer side of the chain stay in the area of the chainring according to the disclosure, on the one hand, the chain stay is protected in this area so that when the chain moves, it does not rub against the chain stay in this area or strike against this area of the chain stay and damage it. This is extremely relevant, in particular for chain stays made of carbon fiber or the like, to ensure the stability of the chain stay. Furthermore, the arrangement of a cover element in this area of the chain stay according to the disclosure has the advantage that the risk of the chain jumping off is reduced, since the distance between chain plate and chain stay is reduced by the cover element. Here, the cover element is preferably at least partially arranged in the space between chainring and chain stay. Even if the chain jumps off the chainring, the arrangement of the cover element according to the disclosure reduces the risk of jamming, and even if jamming does occur, the risk of damage to the chain stay is reduced. Damage to the chain itself can also be reduced, for example, by producing the cover element from a material that is softer than the chain so that the cover element but not the chain is damaged.

The area on the outer side of the chain stay in which the cover element is arranged is preferably the area of the chain stay directly adjacent to the chainring. This is the area of the chain stay arranged directly behind the chainring in plan view or side view in the direction of travel. It is further preferred that the covered area is also arranged at least partially behind the chainring in plan view so that the cover element is arranged behind the teeth of the chainring, in particular in plan view. In this respect, preferably at least a part of the cover element is arranged in the mounted state between the chainring and the chain stay, in particular in the area of the teeth of the chainring, in plan view.

It is further preferred that the cover element is configured to be arc-shaped, being in particular a configuration substantially having the shape of a circular arc. The cover element thus preferably follows the arc of the chainring in terms of shape. In particular, the arc-shaped configuration of the cover element is substantially coaxial to the chainring. In this respect, the cover element is preferably a ring-segment-shaped element whose center is arranged in the area of the bottom bracket. Of course, such a ring segment or arc-shaped cover element can have lugs and the like.

Furthermore, it is preferred that the cover element has such dimensions that it extends across the entire height of the outer side of the chain stay in the mounted state. Preferably, the cover element additionally encompasses at least partially a lower side and/or an upper side of the chain stay. For example, this prevents the chain from getting caught if it jumps off the chainring. It is particularly preferred that the fastening element connected to the cover element is arranged in the area of the upper side of the chain stay. Preferably, fastening is achieved, for example, by means of a screw or another fixing element. It is particularly preferred that the fastening element can be connected in different positions to the chain stay, in particular the upper side of the chain stay. For this purpose, several holes can be provided in the fastening element so that the fastening element and thus also the cover element connected thereto can be arranged in different positions. Preferably, the fastening element has an oblong hole so that a stepless displacement of the fastening element and the cover element connected thereto is possible. This in particular has the advantage that the position of the chain stay protection element can be adapted to chainrings of different sizes. For example, this is advantageous when exchanging chain rings.

In a further preferred embodiment of the chain stay protection element according to the disclosure, the cover element has a lug. The lug encompasses the chainring in the mounted state. In particular, some teeth of the chainring are encompassed here. Preferably, the chainring is encompassed at the level of the chain stay. Preferably, this is below the chain, i.e. below the upper chain strand. This prevents the chain from jamming between the chainring and the frame, or between the frame and the chainring and a part of the chain stay protection element, when the chain jumps off inwards. Rather, the chain rests in particular on an upper side of said lug when the chain has jumped off the chainring.

As an alternative or in addition to providing a lug on the cover element, the cover element has a groove in which the teeth of the chainring are arranged in the mounted state or through which the teeth pass when moving the chainring. This has the same effect and provides the additional advantage that a part of the chain stay protection element is also arranged on the inner side of the chainring, i.e. between the chainring and the frame, in particular the chain stay. This further reduces the risk of the chain jamming when jumping off between the chainring and the frame or the chain stay protection element, respectively.

In addition, the chain stay protection element can have a protection element connected to the cover element and/or the fastening element. Said protection element is arranged on the upper side of the chain stay and thus serves to protect the chain stay in the event of a moving, for example oscillating chain. The chain then strikes the protection element and not the upper side of the chain stay. In particular, the protection element extends from the fastening element and/or cover element in the direction of a fork end of the chain stay. Preferably, the protection element extends over at least ⅔ of the length of the chain stay from the cover element or from the chainring, respectively. Preferably, the protection element is additionally fastened to the upper side of the chain stay by means of screws or other fixing elements. The protection element may be a separate element, wherein the protection element may also be integrally formed with the cover element and/or the fastening element.

In another preferred further embodiment of the disclosure, the chain stay protection element has a chain guide element. The chain guide element is connected to the fastening element and/or the cover element and may also be integrally formed therewith. The chain guide element partially encompasses the chain in the mounted state, in particular above the chainring. Preferably, the chain guide element has a lug which is arranged above the chain in the mounted state. The distance to the chain is so small that the chain cannot be lifted off the teeth of the chainring. Furthermore, the chain guide can also have a lug which is arranged on the front side or the outer side of the chainring so that the chain is also prevented from slipping down towards the front. Preferably, the chain guide element is configured such that it can be arranged in different positions. This makes it possible to adjust the chain guide element and, in particular, to adapt the position of the chain guide element when replacing chainrings with different diameters. For example, an oblong hole or several openings for fixing in different positions can be used for adjustment.

The disclosure further relates to a chain stay system. The chain stay system comprises a chain stay of a bicycle rear frame. The system also comprises a chain stay protection element connected to the chain stay and having a cover element and a fastening element as described above. Particularly preferably, the chain stay protection element, as described above, is further developed. Furthermore, the chain stay system may comprise a chainring arranged particularly as described above with reference to the chain stay protection member. In addition, the chain stay system may also comprise a bicycle chain, again preferably arranged as described above with reference to the chain stay protection element.

### BRIEF DESCRIPTION OF THE DRAWINGS

In the following, the disclosure is described in more detail by means of preferred embodiments with reference to the accompanying drawings.

In the drawings:

FIG. 1 is a schematic perspective view of a first embodiment of a chain stay protection element in the mounted state,

FIG. 2 is a side view of the chain stay protection element shown in FIG. 1 in the mounted state together with a chainring,

FIG. 3 is a perspective view of a second embodiment of a chain stay protection element, and

FIG. 4 is a perspective plan view of the chain stay protection element shown in FIG. 3.

### DETAILED DESCRIPTION

In the Figures, two embodiments of a chain stay protection element are illustrated in conjunction with the chain stay and possibly also with the chainring so that the chain stay system is also illustrated.

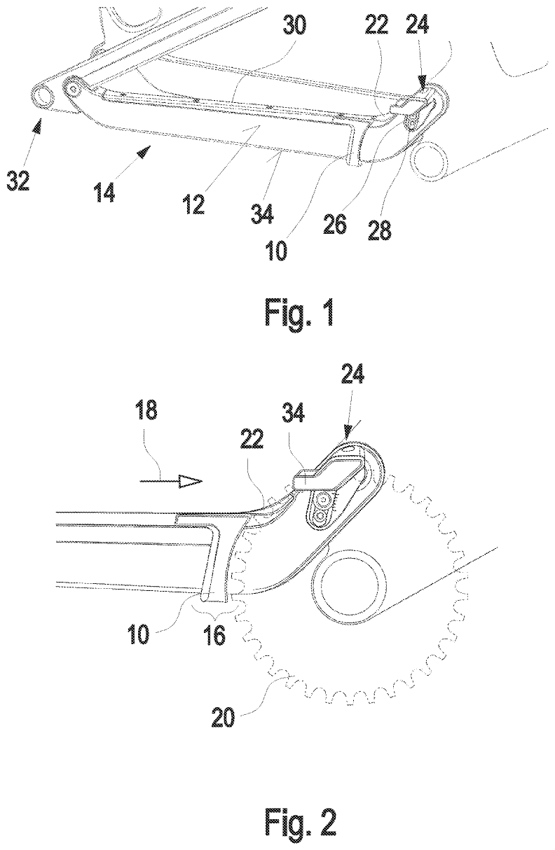

According to a first preferred embodiment (FIGS. 1 and 2), the chain stay protection element has a cover element 10. The cover element 10 is arranged on an outer side 12 of chain stay 14 in the mounted state. As can be seen in particular from FIG. 2, cover element 10 is arranged in an area 16. The area 16 is an area of a chainring. In the illustrated exemplary embodiment, area 16 is the area adjoining a circumference of a chainring 20 in a direction opposite to a direction of travel 18. The cover element 10 could also be arranged slightly wider or slightly further forward in the direction of travel, so that it is at least partially arranged below the chainring, in particular the teeth of chainring 20, in plan view (FIG. 2).

A fastening element 22 is connected to cover element 10 or integrally formed therewith. The fastening element 22 arranged on an upper side of chain stay 14 can fasten the chain stay protection element to chain stay 14 by means of a screw or the like.

Furthermore, in the illustrated exemplary embodiment, a chain guide element 24 is connected to fastening element 22. The chain guide element may also be integrally formed with fastening element 22. The chain guide element 24 may also be part of fastening element 22 so that the fastening is achieved by means of a screw 26 (FIG. 1), for example. In the illustrated exemplary embodiment, screw 26 is arranged in an oblong hole so that chain guide element 24 can be adjusted in particular in vertical direction. This is particularly advantageous when replacing the chainring as it makes it easy to adapt to chainrings of different sizes.

Furthermore, in the illustrated exemplary embodiment, a protection element 30 is connected to cover element 10 or fastening element 22, respectively. The protection element 30 is arranged on an upper side of chain stay 14 and encompasses chain stay 14 in the illustrated exemplary embodiment on outer side 12 and on the opposite inner side. The protection element is thus U-shaped in cross-section. In the illustrated exemplary embodiment, protection element 30 extends across the entire length of chain stay 12 from the chainring-side end or from cover element 10, respectively, in the direction of a fork end 32 of the rear frame, which serves to accommodate the rear wheel axle.

As can be seen in particular in FIG. 2, the chain guide element may be configured such that it has a lug 34 encompassing chainring 20 in the mounted state or being arranged on the outer side of chainring 20 in plan view (FIG. 2), respectively.

The cover element 10 may further be configured such that it at least partially encompasses a lower side 34 of chain stay 14 in order to ensure a secure reliable connection with chain stay 14.

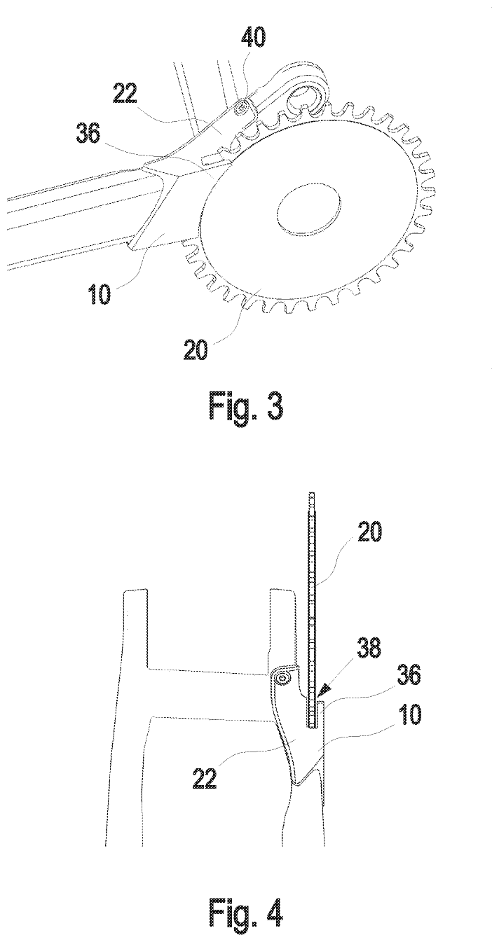

In a second preferred embodiment (FIGS. 3 and 4) similar and identical components are designated with the same reference signs.

The main difference between these two embodiments is that element 10 additionally has a lug 36. In the illustrated exemplary embodiment, a groove 38 is formed by lug 36 in which the teeth of the chainring 20 are arranged. The lug 36 is thus arranged in front of or outside of chainring 20, respectively, in the mounted state in plan view. In the illustrated exemplary embodiment, fastening is preferably again achieved by means of a fastening element 22, which in the illustrated embodiment comprises a screw 40.

The embodiment illustrated in FIGS. 3 and 4 can, of course, be supplemented to include an additional chain guide element 24 and/or a protection element 30.

1. A chain stay protection element for arrangement on a chain stay of a bicycle, comprising:
a cover element arranged on an outer side of the chain stay in the area of the chainring in the mounted state, and
a fastening element connected to the cover element for fastening to the chain stay.

2. The chain stay protection element for arrangement on a chain stay according to claim 1, wherein the covered area includes the area of the chainring directly adjacent to the chainring.

3. The chain stay protection element for arrangement on a chain stay according to claim 1, wherein the covered area includes an area arranged behind the chainring, in particular the teeth of the chainring, in plan view.

4. The chain stay protection element for arrangement on a chain stay according to claim 1, wherein at the cover element is configured to be arc-shaped, in particular circular arc-shaped, the cover element preferably being arranged substantially coaxially to the chainring.

5. The chain stay protection element for arrangement on a chain stay according to claim 1, wherein the cover element extends across the entire height of the outer side of the chain stay.

6. The chain stay protection element for arrangement on a chain stay according to claim 1, wherein the cover element at least partially encompasses a lower side of the chain stay.

7. The chain stay protection element for arrangement on a chain stay according to claim 1, wherein the fastening element is arranged on an upper side of the chain stay.

8. The chain stay protection element for arrangement on a chain stay according to claim 1, wherein the fastening element is adapted to be connected in different positions to the chain stay, in particular the upper side of the chain stay.

9. The chain stay protection element for arrangement on a chain stay according to claim 1, wherein the cover element has a lug encompassing the chainring in the mounted state.

10. The chain stay protection element for arrangement on a chain stay according to claim 1, wherein the cover element has a groove in which the teeth of the chainring are arranged in the mounted state.

11. The chain stay protection element for arrangement on a chain stay according to claim 1, wherein the cover element and/or the fastening element are connected to a protection element arranged on an upper side of the chain stay, said protection element extending in the direction of a fork end of the chain stay.

12. The chain stay protection element for arrangement on a chain stay according to claim 1, wherein the fastening element and/or the cover element is connected to a chain guide element.

13. The chain stay protection element for arrangement on a chain stay according to claim 12, wherein the chain guide element is adapted to be fastened in different positions.

14. A chain stay system, comprising
a chain stay of a bicycle rear frame, and
a chain stay protection element according to claim 1 connected to the chain stay.
